(19) United States
(12) Patent Application Publication
(10) Pub. No.: US 2025/0230105 A1
(43) Pub. Date: Jul. 17, 2025

(54) MINERAL-BASED EXPANDING FOAM

(71) Applicant: WACKER CHEMIE AG, Munich (DE)

(72) Inventors: Holger BIENERTH, Munich (DE); Klaus BONIN, Burghausen (DE); Josef BRUMMER, Simbach (DE); Klaus-Jürgen EDER, Mitterskirchen (DE); Harald ZEH, Burghausen (DE)

(73) Assignee: WACKER CHEMIE AG, Munich (DE)

(21) Appl. No.: 18/853,492

(22) PCT Filed: Apr. 4, 2022
(86) PCT No.: PCT/EP2022/058907

§ 371 Date: Oct. 2, 2024

(51) Int. Cl. C04B 38/10; C04B 28/06; C04B 111/00

(52) U.S. Cl. CPC C04B 38/10; C04B 28/06; C04B 2111/00663

(57) ABSTRACT

A mineral expanding foam is based on one or more foam stabilizers, one or more air pore formers selected from the group comprising ammonium salts or alkali metal salts of the hydrogencarbonates or carbonates, optionally one or more fillers, and optionally one or more additives. The mineral expanding foam is additionally based on one or more protective colloid-stabilized polymers of ethylenically unsaturated monomers in the form of aqueous dispersions or water-redispersible powders, one or more latent air pore formers selected from the group comprising aluminum and silicon and alloys thereof and calcium carbides and 30% to 95% by weight, based on the dry weight of the mineral expanding foam, of cement. The proportion of latent air pore formers is ≥10% by weight, based on the total weight of air pore formers and latent air pore formers

The invention relates to mineral expanding foam, to processes for producing mineral expanding foam and to the use thereof for filling cavities for example when installing windows or doors.

At present, polyurethane foams are usually used to fill cavities when installing windows or doors. However, polyurethanes are associated with a whole series of disadvantages. By way of example, polyurethanes are not UV-resistant, have a tendency toward yellowing and are in particular not fire-resistant. When filling cavities, an excess of polyurethane foam is usually applied, which then adheres for example to the masonry or to the windows or doors and can generally no longer be removed without leaving residues. Residues left over from applying polyurethane foam or construction waste contaminated with polyurethane foam must be disposed of as hazardous waste. Polyurethane foam is usually applied by means of cartridges, which cannot be cleaned after their use and are therefore not recyclable and have to be disposed of at great cost and inconvenience. Furthermore, there is a need for a more cost-effective alternative to polyurethanes.

Against this background, the object was to provide a material for filling cavities that makes it possible to solve one or more of the problems mentioned above. In particular, this material should be able to be applied by means of cartridges.

Surprisingly, the object was achieved with mineral expanding foam that contained protective colloid-stabilized polymers, foam stabilizers and specific air pore formers and additionally latent air pore formers, and cement. It was particularly surprising here that the mineral expanding foam was also able to be applied as a one-component mixture (1K system) in cartridges for filling cavities.

Cementitious foam mortars with air pore formers and foam stabilizers are known for example from WO2021/180309 or WO2019038105. In WO/EP2021/062371 (application number) and DE102014101519, corresponding foam mortars are used as tile adhesive and as filling compound, respectively. CN108484211 and CN108529940 recommend foam mortars as insulation material. DE4209897 and DE3909083 describe gypsum-based foam mortars. GB20047636 is concerned with silicate foams. DE2056255 discloses foaming agents for gypsum and cement compositions. DE4009967 teaches mortars with pore formers that are provided with an inactivating coating. US2012-286190 describes thermal insulation material based on quick-setting cement and small amounts of Portland cement, and fillers and optionally additives as foam formers.

The invention provides mineral expanding foam based on one or more foam stabilizers, one or more air pore formers selected from the group comprising ammonium salts or alkali metal salts of the hydrogencarbonates or carbonates,
optionally one or more fillers and
optionally one or more additives, characterized in that the mineral expanding foam is additionally based on
one or more protective colloid-stabilized polymers of ethylenically unsaturated monomers in the form of aqueous dispersions or water-redispersible powders,
one or more latent air pore formers selected from the group comprising aluminum and silicon and alloys thereof and calcium carbides and
30% to 95% by weight, based on the dry weight of the mineral expanding foam, of cement, with the proviso that the proportion of latent air pore formers is ≥10% by weight, based on the total weight of air pore formers and latent air pore formers.

The invention further provides processes for producing mineral expanding foam, in that a dry mixture is produced by mixing
one or more foam stabilizers,
one or more air pore formers selected from the group comprising ammonium salts or alkali metal salts of the hydrogencarbonates or carbonates,
optionally one or more fillers and
optionally one or more additives and
the thus obtained dry mixture is made up with water, characterized in that one or more protective colloid-stabilized polymers of ethylenically unsaturated monomers in the form of water-redispersible powders,
one or more latent air pore formers selected from the group comprising aluminum and silicon and alloys thereof and calcium carbides and
30% to 95% by weight, based on the dry weight of the mineral expanding foam, of cement are additionally introduced into the dry mixture,
with the proviso that the dry mixture is based on latent air pore formers to an extent of ≥10% by weight, based on the total weight of air pore formers and latent air pore formers.

The invention further provides for the use of the mineral expanding foam according to the invention for filling cavities for example when installing windows or doors.

The invention further provides processes for filling cavities, for example when installing windows or doors, characterized in that the cavities are filled with mineral expanding foam according to the invention.

Mineral expanding foam is generally a mortar that implicitly contains air pores to an increased extent. The air pores of the mineral expanding foam may be introduced for example by means of air pore formers and optionally by introduction of air.

The figures given below in % by weight, based on the dry weight of the mineral expanding foam, are generally based on the dry weight of the components for producing the mineral expanding foam.

Examples of air pore formers are ammonium salts or alkali metal salts of the hydrogencarbonates or carbonates, particularly the ammonium or sodium or potassium salts thereof. Particular preference is given to hydrogencarbonates. Most preferred is sodium hydrogencarbonate. The air pore formers preferably do not comprise any alkaline earth metal carbonate.

Air pore formers have a grain size of preferably 10 μm to 1 mm, particularly preferably of 100 μm to 800 μm and most preferably 200 μm to 700 μm.

The air pore formers are generally different from the latent air pore formers; that is to say, the air pore formers are used in addition to the latent air pore formers as further or additional air pore formers; or, in other words, the mineral expanding foam generally contains one or more air pore formers i) and one or more latent air pore formers ii). Air pore formers i) generally do not comprise any latent air pore formers ii).

The mineral expanding foam is based on air pore formers to an extent of preferably 0.01% to 10% by weight, more preferably 0.05% to 5% by weight, more preferably still 0.08% to 3% by weight, particularly preferably 0.1% to 1% by weight and most preferably 0.2% to 0.8% by weight, based on the dry weight of the mineral expanding foam.

The mineral expanding foam is based on air pore formers to an extent of preferably 0.01% to 15% by weight, particularly preferably 0.1% to 5% by weight and most preferably 0.2% to 1% by weight, based on the dry weight of the cement present in the mineral expanding foam.

The introduction of air to produce mineral expanding foam may optionally additionally be effected by mechanically mixing aqueous mortars with air. For this purpose, the aqueous mortars may for example be beaten, with air mixed into them. The mechanical mixing is preferably effected by means of stirring blades, mixing coils, paddle stirrers, propeller stirrers or perforated-plate stirrers. Particular preference is given to mixing coils with perforated plates. Use may also be made of foam generators. Foam generators are commercially available machines for generating foam. It is also possible to blow air into the aqueous mortars. The air preferably has a temperature of 5° C. to 35° C., in particular ambient temperature.

Examples of latent air pore formers are aluminum and silicon and alloys thereof or calcium carbides. Aluminum, silicon and alloys thereof are generally present here in metallic form. Suitable as alloys are for example alloys of aluminum or silicon with metals, such as iron. Preference is given to aluminum. The latent air pore formers may optionally be coated, for example with fats, oils, resins or waxes, such as lanolin, in particular wool wax, or drying oils, such as linseed oil, silicone oils or silicone resins. With such coatings, the release of air pores in the mineral expanding foam may additionally be delayed in a temporally controlled manner, for example via the type or thickness of the coating. The latent air pore formers are preferably in the form of powders or particles. Corresponding latent air pore formers are commercially available, for example under the trade name Expandal 9-6355 from Benda-Lutz.

The mineral expanding foam is based on latent air pore formers to an extent of 0.01% to 10% by weight, particularly preferably 0.1% to 5% by weight, more preferably still 0.5% to 4% by weight and most preferably 1% to 3% by weight, based on the dry weight of the mineral expanding foam.

The mineral expanding foam is based on latent air pore formers to an extent of preferably 0.01% to 15% by weight, particularly preferably 0.5% to 10% by weight and most preferably 1% to 5% by weight, based on the dry weight of the cement present in the mineral expanding foam.

The mineral expanding foam is based on latent air pore formers generally to an extent of ≥ 10% by weight, preferably 10% to 95% by weight, particularly preferably 50% to 90% by weight and most preferably 75% to 85% by weight, based on the total weight of latent air pore formers and the further air pore formers.

The mineral expanding foam is based on latent air pore formers and the further air pore formers to an extent of preferably 0.01% to 15% by weight, particularly preferably 0.5% to 10% by weight and most preferably 1% to 5% by weight, based on the dry weight of the cement present in the mineral expanding foam. The mineral expanding foam is based on latent air pore formers and the further air pore formers to an extent of preferably 0.02% to 15% by weight, particularly preferably 0.5% to 10% by weight and most preferably 1% to 5% by weight, based on the dry weight of the mineral expanding foam. The further air pore formers here are generally the air pore formers mentioned above that differ from the latent air pore formers.

Use may for example be made of surfactant-, polymer-, protein- or enzyme-based foam stabilizers.

Examples of surfactants as foam stabilizers are olefinsulfonic acids; fatty acids, having preferably 16 to 18 carbon atoms, or salts thereof; fatty alcohols, having preferably 10 to 18 carbon atoms; alkylphenols or hydroxyalkylphenols having preferably alkyl chains having 10 to 18 carbon atoms; alkyl and alkylaryl ether sulfates having preferably 8 to 18 carbon atoms in the hydrophobic radical and preferably 1 to 50 ethylene oxide units; sulfonates, in particular alkylsulfonates having preferably 8 to 18 carbon atoms, alkylarylsulfonates, preferably having alkyl radicals having 8 to 18 carbon atoms, esters or monoesters of sulfosuccinic acid with preferably monohydric alcohols or alkylphenols having preferably 4 to 15 carbon atoms in the alkyl radical, where these alcohols or alkylphenols may also have been ethoxylated with 1 to 40 ethylene oxide units; partial phosphoric esters, in particular alkyl or alkylaryl phosphates having 8 to 20 carbon atoms in the organic radical, alkyl ether phosphates and alkylaryl ether phosphates having 8 to 20 carbon atoms in the alkyl or alkylaryl radical and 1 to 50 EO units; alkyl polyglycol ethers preferably having 8 to 40 EO units and alkyl radicals having 8 to 20 carbon atoms; alkylaryl polyglycol ethers preferably having 8 to 40 EO units and 8 to 20 carbon atoms in the alkyl and aryl radicals; ethylene oxide/propylene oxide (EO/PO) block copolymers preferably having 8 to 40 EO or PO units; N-methyl taurides preferably of higher fatty acids, having preferably 10 to 18 carbon atoms; fatty acid alkylolamides, such as mono-or diethanolamides of fatty acids; amine oxides or phosphine oxides, such as cocodimethylamine oxide or cocodimethylphosphine oxide of the general formula R−N(CH₃)₂=0 or R−P(CH₃)₂=0; ampholytes, such as sodium cocoyl dimethylaminoacetate or sulfobetaine; phosphoric esters in particular of long-chain alcohols, having preferably 10 to 18 carbon atoms, or of alcohols that have been ethoxylated with 1 to 4 mol of ethylene oxide and have 8 to 10 carbon atoms in the molecule.

Preferred surfactants here are olefinsulfonic acids, fatty acids, fatty alcohols, alkyl and alkylaryl ether sulfates and sulfonates.

An EO unit is an ethylene oxide unit and a PO unit is a propylene oxide unit. The aforementioned acids may also be in the form of their salts, in particular ammonium or alkali (ne earth) metal salts. Olefinsulfonic acids preferably contain 10 to 20 carbon atoms. The olefinsulfonic acids preferably bear one or two sulfonic acid or hydroxyalkylsulfonic acid groups. Preference is given here to a-olefinsulfonic acids.

Examples of polymers as foam stabilizers are polyvinyl alcohols; polyvinyl acetals; polyvinylpyrrolidones; polysaccharides in water-soluble form, such as starches (amylose and amylopectin), celluloses and derivatives thereof, such as carboxymethyl, methyl, hydroxyethyl, hydroxypropyl derivatives, dextrins and cyclodextrins; lignosulfonates; poly(meth)acrylic acid; copolymers of (meth)acrylates with carboxy-functional comonomer units; poly(meth)acrylamide; polyvinylsulfonic acids and water-soluble copolymers thereof; melamine-formaldehydesulfonates; naphthalene-formaldehydesulfonates; styrene-maleic acid copolymers and vinyl ether-maleic acid copolymers.

Examples of proteins as foam stabilizers are casein, caseinate, soy protein or gelatin. Proteins are for example obtainable by protein hydrolysis, in particular of animal proteins, for example from horn, blood, bone and similar wastes from cattle, pigs and other animal carcasses. Enzymes as foam stabilizers may for example be of biotechnological origin.

Preferred foam stabilizers are surfactants; polyvinyl alcohols; polyvinylpyrrolidones; celluloses and derivatives thereof, such as carboxymethyl, methyl, hydroxyethyl, hydroxypropyl derivatives; proteins such as casein or caseinate, soy protein and gelatin. Particularly preferred foam stabilizers are surfactants, in particular olefinsulfonic acids.

Particular preference is given to the joint use of surfactant foam stabilizers and polymer foam stabilizers.

The foam stabilizers have molecular weights of preferably ≤4000 g/mol, more preferably ≤3000 g/mol, more preferably still ≤2500 g/mol, particularly preferably ≤1500 g/mol and most preferably ≤1000 g/mol.

The foam stabilizers and the protective colloid-stabilized polymers are generally present alongside one another. The foam stabilizers are generally not a constituent of the protective colloid-stabilized polymers.

The mineral expanding foam is based on foam stabilizers to an extent of preferably 0.01% to 35% by weight, particularly preferably 0.05% to 20% by weight and most preferably 0.1% to 10% by weight. Surfactants or polymers as foam stabilizers are present to an extent of preferably 0.01% to 10% by weight, particularly preferably 0.05% to 5% by weight and most preferably 0.1% to 3% by weight. Proteins or enzymes as foam stabilizers are present to an extent of preferably 10% to 35% by weight, particularly preferably 15% to 30% by weight and most preferably 20% to 25% by weight. The figures in % by weight are based here on the dry weight of the mineral expanding foam.

The mineral expanding foam is based on protective colloid-stabilized polymers of ethylenically unsaturated monomers to an extent of preferably 0.5% to 40% by weight, particularly preferably 2% to 25% by weight and most preferably 5% to 15% by weight, based on the dry weight of the mineral expanding foam.

The polymers of ethylenically unsaturated monomers are based for example on one or more monomers selected from the group comprising vinyl esters, (meth)acrylic esters, vinylaromatics, olefins, 1,3-dienes and vinyl halides.

Suitable vinyl esters are for example those of carboxylic acids having 1 to 15 carbon atoms. Preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9R or VeoVa10R (trade names of Resolution). Particular preference is given to vinyl acetate.

Suitable monomers from the group of acrylic esters or methacrylic esters are for example esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, 2-ethylhexyl acrylate. Particular preference is given to methyl acrylate, methyl methacrylate, n-butyl acrylate, t-butyl acrylate and 2-ethylhexyl acrylate.

Preferred vinylaromatics are styrene, methylstyrene and vinyltoluene. A preferred vinyl halide is vinyl chloride. The preferred olefins are ethylene and propylene, and the preferred dienes are 1,3-butadiene and isoprene.

It is optionally also possible to copolymerize 0% to 10% by weight, preferably 0.1% to 5% by weight, based on the total weight of the monomers, of auxiliary monomers. Examples of auxiliary monomers are ethylenically unsaturated mono-and dicarboxylic acids, preferably acrylic acid, methacrylic acid, fumaric acid and maleic acid; ethylenically unsaturated carboxamides and carbonitriles, preferably acrylamide and acrylonitrile; mono-and diesters of fumaric acid and maleic acid, such as the diethyl and diisopropyl esters, and maleic anhydride; ethylenically unsaturated sulfonic acids or salts thereof, preferably vinylsulfonic acid, and 2-acrylamido-2-methylpropanesulfonic acid. Further examples are precrosslinking comonomers such as polyethylenically unsaturated comonomers, for example diallyl phthalate, divinyl adipate, diallyl maleate, allyl methacrylate or triallyl cyanurate, or postcrosslinking comonomers, for example acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers such as the isobutoxy ether or ester of N-methylolacrylamide, of N-methylolmethacrylamide and of N-methylolallyl carbamate. Also suitable are epoxy-functional comonomers such as glycidyl methacrylate and glycidyl acrylate. Further examples are silicon-functional comonomers, such as acryloxypropyltri (alkoxy)-and methacryloxypropyltri (alkoxy) silanes, vinyltrialkoxysilanes and vinylmethyldialkoxysilanes, where the alkoxy groups present may for example be ethoxy and ethoxypropylene glycol ether radicals. Mention should also be made of monomers having hydroxy or CO groups, for example hydroxyalkyl methacrylates and acrylates such as hydroxyethyl, hydroxypropyl or hydroxybutyl acrylate or methacrylate, and compounds such as diacetone acrylamide and acetylacetoxyethyl acrylate or methacrylate.

Preference is given to copolymers of vinyl acetate with 1% to 50% by weight of ethylene; copolymers of vinyl acetate with 1% to 50% by weight of ethylene and 1% to 50% by weight of one or more further comonomers from the group of vinyl esters having 1 to 12 carbon atoms in the carboxyl radical such as vinyl propionate, vinyl laurate, vinyl esters of alpha-branched carboxylic acids having 9 to 13 carbon atoms such as VeoVa9, VeoVa10, VeoVa11; copolymers of vinyl acetate, 1% to 50% by weight of ethylene and preferably 1% to 60% by weight of (meth)acrylic esters of unbranched or branched alcohols having 1 to 15 carbon atoms, in particular n-butyl acrylate or 2-ethylhexyl acrylate; and copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth) acrylic esters of unbranched or branched alcohols having 1 to 15 carbon atoms, in particular n-butyl acrylate or 2-ethylhexyl acrylate, which also contain 1% to 40% by weight of ethylene; copolymers with vinyl acetate, 1% to 50% by weight of ethylene and 1% to 60% by weight of vinyl chloride; where the polymers may also contain the auxiliary monomers mentioned in the amounts mentioned, and the figures in % by weight add up to 100% by weight in each case.

Preference is also given to (meth)acrylic ester polymers, such as copolymers of n-butyl acrylate or 2-ethylhexyl acrylate or copolymers of methyl methacrylate with n-butyl acrylate and/or 2-ethylhexyl acrylate; styrene-acrylic ester copolymers with one or more monomers from the group of methyl acrylate, ethyl acrylate, propyl acrylate, n-butyl acrylate, 2-ethylhexyl acrylate; vinyl acetate-acrylic ester copolymers with one or more monomers from the group of methyl acrylate, ethyl acrylate, propyl acrylate, n-butyl acrylate, 2-ethylhexyl acrylate and optionally ethylene; styrene-1,3-butadiene copolymers; where the polymers may also contain the auxiliary monomers mentioned in the amounts mentioned, and the figures in % by weight add up to 100% by weight in each case.

Most preferred are copolymers with vinyl acetate and 5% to 50% by weight of ethylene; or copolymers with vinyl acetate, 1% to 50% by weight of ethylene and 1% to 50% by weight of a vinyl ester of a-branched monocarboxylic acids having 9 to 11 carbon atoms; or copolymers with 30% to 75% by weight of vinyl acetate, 1% to 30% by weight of vinyl laurate or vinyl esters of an alpha-branched carboxylic acid having 9 to 11 carbon atoms, and 1% to 30% by weight of (meth)acrylic esters of unbranched or branched alcohols having 1 to 15 carbon atoms, which also contain 1% to 40% by weight of ethylene; or copolymers with vinyl acetate, 5% to 50% by weight of ethylene and 1% to 60% by weight of vinyl chloride.

The monomers and the proportions by weight of the comonomers are selected so as to result in a glass transition temperature Tg of −25° C. to +35° C., preferably −10° C. to +25° C., particularly preferably −10° C. to +20° C. The glass transition temperature Tg of the polymers can be determined in a known manner by differential scanning calorimetry (DSC). An approximate Tg can also be precalculated by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n, and Tgn is the glass transition temperature in kelvin of the homopolymer of the monomer n. Tg values for homopolymers are listed in Polymer Handbook 2nd Edition, J. Wiley & Sons, New York (1975).

The polymers are generally prepared in aqueous medium and preferably by the emulsion or suspension polymerization process-as described for example in DE-A 102008043988. In the polymerization, it is possible to use the standard protective colloids and/or emulsifiers, as described in DE-A 102008043988. The polymers in the form of aqueous dispersions may, as described in DE-A 102008043988, be converted to corresponding water-redispersible powders. In general, use is made here of a drying aid, preferably the aforementioned polyvinyl alcohols.

The polymers may for example be in the form of aqueous dispersions, in particular protective colloid-stabilized aqueous dispersions. Preferred protective colloids are polyvinyl alcohols, such as partially hydrolyzed or fully hydrolyzed polyvinyl alcohols, in particular having a degree of hydrolysis of 80 to 100 mol %. Particular preference is given to partially hydrolyzed polyvinyl alcohols having a degree of hydrolysis of 80 to 94 mol % and a Höppler viscosity of in particular 1 to 30 mPas (Höppler method at 20° C., DIN 53015) in 4% aqueous solution. The protective colloids mentioned are obtainable by means of processes known to those skilled in the art. The protective colloids are generally present in a total amount of 1% to 20% by weight, based on the total weight of polymers.

The polymers are preferably in the form of protective colloid-stabilized, water-redispersible powders. Dispersing the protective colloid-stabilized, water-redispersible polymer powders results in protective colloid-stabilized polymers in the form of aqueous redispersions. The powders contain preferably 3% to 30% by weight, particularly preferably 5% to 20% by weight, of polyvinyl alcohols, in particular the aforementioned polyvinyl alcohols, based on the total weight of the powders.

The protective colloid-stabilized polymers are generally present separately from the air pore formers, latent air pore formers and/or foam stabilizers. The air pore formers, latent air pore formers and/or foam stabilizers are generally not coated with the protective colloid-stabilized polymers. The protective colloid-stabilized polymers or the protective colloids or the polymers of the protective colloid-stabilized polymers are generally different from the foam stabilizers and any thickeners.

Cement may for example be Portland cement (CEM I), Portland slag cement (CEM II), blast furnace slag cement (CEM III), pozzolanic cement (CEM IV), composite cement (CEM V),

Portland silicate dust cement, Portland shale cement, Portland limestone cement, trass cement, magnesia cement, phosphate cement, mixed cements or filler cements or quick-setting cement. Examples of quick-setting cement are aluminate cement, calcium sulfoaluminate cements and high-alumina cement.

Preference is given to Portland cement CEM I, Portland slag cement CEM II/A-S, CEM II/B-S, Portland limestone cement CEM II/A-LL, Portland fly ash cement CEM II/A-V, Portland fly ash slag cement CEM II/B-SV or blast furnace slag cement CEM III/A, CEM III/B, CEM III/B and aluminate cement.

The mineral expanding foam is based on cement to an extent of preferably 40% to 95% by weight, more preferably 50% to 92% by weight, particularly preferably 60% to 91% by weight and most preferably 70% to 90% by weight, based on the dry weight of the mineral expanding foam.

In a preferred embodiment, the mineral expanding foam contains quick-setting cement, for example high-alumina cement, in particular aluminate cement or calcium sulfoaluminate cement, and additionally one or more cements different from quick-setting cement, in particular Portland cements. Quick-setting cement is particularly advantageous for achieving the object according to the invention.

The mineral expanding foam is based on quick-setting cement to an extent of preferably 0.5% to 30% by weight, particularly preferably 1% to 20% by weight and most preferably 2% to 10% by weight, based on the dry weight of the mineral expanding foam. The mineral expanding foam is based on quick-setting cement to an extent of preferably 0.5% to 40% by weight, particularly preferably 1% to 25% by weight and most preferably 2% to 15% by weight, based on the total weight of all the cement used.

The mineral expanding foam may also contain one or more thickeners, for example polysaccharides such as cellulose ethers and modified cellulose ethers, cellulose esters, starch ethers, guar gum, xanthan gum, polycarboxylic acids such as polyacrylic acid and partial esters thereof, casein and associative thickeners. Preferred cellulose ethers are methyl cellulose ethers. The thickeners are generally different from the foam stabilizers. The thickeners have molecular weights of preferably >4000 g/mol, particularly preferably ≥10 000 g/mol and most preferably ≥20 000 g/mol. The mineral expanding foam is based on thickeners to an extent of preferably ≤5% by weight, particularly preferably 0.1% to 3% by weight and most preferably 0.5% to 1.5% by weight, based on the dry weight of the mineral expanding foam.

In addition, the mineral expanding foam may also comprise setting accelerators, such as aluminum compounds, silicates, alkali(ne earth) metal hydroxides, nitrates, nitrites, sulfates, borates or carboxylic acids. Preferred setting accelerators are aluminum salts, aluminates, alkali metal silicates, such as waterglass, alkali metal formates, potassium hydroxide or calcium hydroxide (Ca(OH)₂). Calcium hydroxide is also referred to as hydrated lime or refined hydrated lime. The setting accelerators are generally not in the form of metals, alloys or carbides. The setting accelerators are generally different from latent air pore formers.

The mineral expanding foam is based on setting accelerators to an extent of preferably 0.1% to 15% by weight, more preferably 0.2% to 10% by weight, particularly preferably 0.3% to 7% by weight and most preferably 0.5% to 3% by weight, based on the dry weight of the mineral expanding foam.

The mineral expanding foam may additionally contain fibers, such as natural, modified natural or synthetic fiber materials, based on organic and/or inorganic materials. Examples of natural organic fibers are cotton, hemp, jute, flax, wood fibers, cellulose, viscose, leather fibers or sisal. Examples of synthetic organic fibers are viscose fibers, polyamide fibers, polyester fibers, polyacrylonitrile fibers, Dralon fibers, polyethylene fibers, polypropylene fibers, polyvinyl alcohol fibers or aramid fibers. The inorganic fibers may for example be glass fibers, carbon fibers, mineral wool fibers or metal fibers. Preference is given to cotton fibers, polyacrylonitrile fibers and cellulose fibers. The fibers preferably have a length of 1 to 10 mm, 2 to 6 mm and most preferably 3 mm to 4 mm. The fibers may be used in the form of loose fibers, fibers adhesively bonded in bundles, fibrillated fibers, multifilament fibers or fibers in dose control packages. The mineral expanding foam is based on fibers to an extent of preferably 0.01% to 3% by weight, particularly preferably 0.05% to 1% by weight and most preferably 0.1% to 0.5% by weight, based on the dry weight of the components for producing the mineral expanding foam. Fibers can increase the mechanical stability of the mineral expanding foam and reduce the tendency of the mineral expanding foam toward cracking.

The mineral expanding foam may also contain one or more pozzolans, such as kaolin, microsilica, diatomaceous earth, fly ash, ground trass, ground blast furnace slag, ground glass, precipitated silica and fumed silica. Preferred pozzolans are kaolin, microsilica, fly ash, ground blast furnace slag, in particular metakaolin. The mineral expanding foam is based on pozzolans to an extent of for example 0% to 10% by weight, preferably 0.5% to 5% by weight, based on the dry weight of the mineral expanding foam. Most preferably, the mineral expanding foam does not contain any pozzolans.

Preferably, the mineral expanding foam is based on gypsum to an extent of 0.1% to 20% by weight, more preferably 0.5% to 15% by weight and particularly preferably 1% to 10% by weight, based on the dry weight of the components for producing the mineral expanding foam. Exemplary embodiments of gypsum are α- or β-hemihydrate (CaSO₄·½ H₂O), dihydrate, anhydrite or the calcium sulfate obtained in flue-gas desulfurization (FGD gypsum). In particular, the addition of gypsum makes it possible for example to compensate for any shrinkage in the course of the setting of the mineral expanding foam.

Alternatively, gypsum may be dispensed with. This can for example improve the water resistance of the set mineral expanding foam.

The mineral expanding foam may also contain one or more fillers. Examples of fillers are quartz sand, ground quartz, sand, ground limestone, dolomite, clay, chalk, ground slag sand, white hydrated lime, talc or mica, rubber granules or hard fillers, such as aluminum silicates, corundum, basalt, carbides, such as silicon carbide or titanium carbide. Preferred fillers are quartz sand, ground quartz, ground limestone, calcium carbonate, calcium magnesium carbonate (dolomite), chalk or white hydrated lime. The fillers are generally not in the form of metals, alloys or carbides. The fillers are generally different from latent air pore formers. Fillers have a grain size of preferably ≤2 mm, particularly preferably ≤1 mm.

The mineral expanding foam is based on fillers to an extent of preferably ≤10% by weight, particularly preferably ≤5% by weight, based on the dry weight of the mineral expanding foam.

Most preferably, the mineral expanding foam does not contain any fillers.

The mineral expanding foam may also comprise lightweight fillers. “Lightweight fillers” generally refers to fillers having a low bulk weight, usually of less than 500 g/l. The lightweight fillers are preferably different from the aforementioned fillers. Particularly preferably, the mineral expanding foam does not contain any further fillers in addition to lightweight fillers. Typical lightweight fillers, on a synthetic or natural basis, are substances such as hollow microbeads of glass, polymers such as polystyrene beads, aluminosilicates, silicon oxide, aluminum silicon oxide, calcium silicate hydrate, silicon dioxide, aluminum silicate, magnesium silicate, aluminum silicate hydrate, calcium aluminum silicate, calcium silicate hydrate, aluminum iron magnesium silicate, calcium metasilicate and/or volcanic slag. Preferred lightweight fillers are perlite, Celite, Cabosil, Circosil, Eurocell, Fillite, Promaxon, Vermex and/or wollastonite, and polystyrene. The lightweight fillers are generally not in the form of metals, alloys or carbides. The fillers are generally different from latent air pore formers.

The mineral expanding foam is based on lightweight fillers to an extent of preferably 0% to 10% by weight, more preferably 0.5% to 5% by weight and particularly preferably 1% to 3% by weight, based on the dry weight of the mineral expanding foam. Most preferably, the mineral expanding foam does not contain any lightweight fillers.

Optionally, the mineral expanding foam may also contain additives, for example plasticizers, superplasticizers, retardants, film-forming aids, dispersants, plasticizers, hydrophobizing agents, pigments, preservatives, flame retardants (e.g. aluminum hydroxide), finely divided silica. Preferred additives are superplasticizers, plasticizers and in particular hydrophobizing agents. Additives are present to an extent of preferably 0% to 20% by weight, particularly preferably 0.1% to 10% by weight and most preferably 0.5% to 7% by weight, based on the dry weight of the mineral expanding foam.

Examples of hydrophobizing agents are fatty acids or derivatives thereof, waxes and organosilicon compounds, such as silanes or siloxanes.

Examples of organosilicon compounds are silanes of formula (I) and/or mixtures thereof and/or hydrolyzates thereof, in particular oligomers or polymers of the hydrolyzates,

(RO)₄₋ₙSiR′ₙ (I),
where n assumes values of 1 to 3,
where each R′ is the same or different and is branched or unbranched alkyl radicals having 1 to 22 carbon atoms, cycloalkyl radicals having 3 to 10 carbon atoms, alkylene radicals having 2 to 4 carbon atoms, and aryl, aralkyl, alkylaryl radicals having 6 to 18 carbon atoms, and R is the same or different alkyl radicals and alkoxyalkylene radicals having in each case 1 to 20 carbon atoms, in particular 1 to 4 carbon atoms, or trimethylsilyl radicals or hydrogen, preferably methyl and ethyl.

Preferably R′ is an alkyl radical having 1 to 12 carbon atoms, particularly preferably having 1 or 8 carbon atoms. The alkyl radicals may be linear or branched. Preferably R is a hydrogen, alkyl radical having 1 to 4 carbon atoms, such as methyl, ethyl, propyl or butyl radical, in particular an ethyl radical.

The organosilicon compounds may be introduced for example in pure, solid or preferably liquid form. The organosilicon compounds may be added undiluted or diluted, for example diluted with solvents such as alcohols, in particular ethanol, or in the form of aqueous emulsions. Furthermore, the organosilicon compounds may be used in the form of powders. Liquid organosilicon compounds are preferably used in supported form, for example absorbed on a support, such as silica, or as an encapsulated powder, for example encapsulated with polyvinyl alcohols or alginates.

Corresponding organosilicon compounds are commercially available.

Preferred fatty acids or fatty acid derivatives are selected from the group of saturated and unsaturated fatty acids having 8 to 22 carbon atoms, metal soaps thereof, amides thereof and esters thereof with monohydric alcohols having 1 to 14 carbon atoms, with glycol, with polyglycol, with polyalkylene glycol, with glycerol, with mono-, di- or triethanolamine, with monosaccharides and with polyhydroxy compounds.

Particularly preferred fatty acids are lauric acid (n-dodecanoic acid), myristic acid (n-tetradecanoic acid), palmitic acid (n-hexadecanoic acid), stearic acid (n-octadecanoic acid) and oleic acid (9-dodecenoic acid).

Particularly preferred metal soaps are those of the preferred C₈- to C₂₂-fatty acids with metals of main groups 1 to 3 or transition group 2 of the PTE, and with ammonium compounds NX₄⁺, where X is the same or different and is H, C₁- to C₈-alkyl radical and C₁- to C₈-hydroxyalkyl radical. Most preferred are metal soaps with lithium, sodium, potassium, magnesium, calcium, aluminum, zinc, and the ammonium compounds.

Particularly preferred fatty acid amides are the fatty acid amides obtainable with mono-or diethanolamine and the C₈- to C₂₂-fatty acids mentioned above.

Particularly preferred fatty acid esters are the C₁- to C₁₄-alkyl esters and-alkylaryl esters of the C₈- to C₂₂-fatty acids mentioned, preferably methyl, ethyl, propyl, butyl, ethylhexyl esters and the benzyl esters. Particularly preferred fatty acid esters are also the mono-, di- and polyglycol esters of the C₈- to C₂₂-fatty acids. Further particularly preferred fatty acid esters are the mono-and diesters of polyglycols and/or polyalkylene glycols having up to 20 oxyalkylene units, such as polyethylene glycol and polypropylene glycol. Particular preference is also given to the mono-, di- and tri-fatty acid esters of glycerol with the C₈- to C₂₂-fatty acids mentioned, and the mono-, di- and tri-fatty acid esters of mono-, di- and triethanolamine with the C₈- to C₂₂-fatty acids mentioned. Particular preference is also given to the fatty acid esters of sorbitol and mannitol. Particular preference is given to the C₁- to C₁₄-alkyl esters and alkylaryl esters of lauric acid and of oleic acid, mono- and diglycol esters of lauric acid and of oleic acid, and the mono-, di- and tri-fatty acid esters of glycerol with lauric acid and with oleic acid.

The mineral expanding foam contains hydrophobizing agents to an extent of preferably 0.01% to 5% by weight, particularly preferably 0.05% to 2% by weight and most preferably 0.1% to 0.8% by weight, based on the dry weight of the mineral expanding foam.

The mineral expanding foam preferably does not contain any hexafluorosilicic acid, in particular any salts of hexafluorosilicic acid, such as calcium, magnesium, zinc or ammonium salts.

The mineral expanding foam is preferably a 1K system; that is to say, all constituents of the mineral expanding foam are preferably mixed in a mixing device. Particularly preferably, mineral expanding foam is first produced in the form of a dry mixture, and then water is added.

The individual constituents of the mineral expanding foam may be mixed in standard mixing devices, for example with mortar mixing assemblies, machine drill stirrers, dissolvers or mixing-coil stirrers, preferably at a speed of the stirring or mixing assembly of >100 rpm. This generally introduces air pores into the mineral expanding foam, for example by means of air pore formers and optionally by introduction of air, as already described further above.

On addition of water, the mineral expanding foam is mixed and made up for preferably 1 to 10 minutes, particularly preferably 2 to 5 minutes. The mixing is preferably effected at 5° C. to 35° C., particularly preferably 15° C. to 25° C.

To produce the aqueous mineral expanding foam, use is made of 4% to 30% by weight, particularly preferably 6% to 20% by weight and most preferably 8% to 15% by weight of water, based on the dry weight of the mineral expanding foam.

The application of the aqueous mineral expanding foam may be effected for example immediately after it is made up with water and is effected preferably not more than 10 minutes, particularly preferably not more than 5 minutes, after it is made up with water.

The mineral expanding foam generally contains air pores. The mineral expanding foam preferably has a cream-like or creamy consistency. The mineral expanding foam has a wet density of preferably 100 to 1000 kg/m³, particularly preferably 200 to 900 kg/m³ and most preferably 300 to 800 kg/m³. The density may be determined in a conventional manner, for example by filling a container with a defined volume of the foam, and weighing.

Preferably, the thus obtained mineral expanding foam is applied immediately after it has been produced, in particular without a further processing step.

The mineral expanding foam is preferably used for filling cavities for example when installing windows or doors, in particular for filling cavities between window or door frames and window or door reveals. Moreover, the mineral expanding foam may also be used for filling cavities when installing roller shutter boxes or for filling slots when laying pipes or cables. The mineral expanding foam is also suitable for filling cavities in formwork construction or between precast concrete parts or other spaces. Furthermore, cavities in shipbuilding may also be filled with the mineral expanding foam.

The mineral expanding foam may advantageously be applied in a manner which is conventional per se, as known for example from the filling of cavities with polyurethane foams (PU foams). For instance, aqueous mineral expanding foam may be applied to a substrate mechanically, for example using a sprayer, or preferably manually, for example using a spatula or preferably by means of a cartridge filled with aqueous mineral expanding foam. Any protruding residues of mineral expanding foam may be removed for example by means of a spatula or washed off before or after it has set.

The mineral expanding foam may be applied here to standard substrates, for example to mineral substrates, such as natural stones, bricks, tiles, concrete blocks, aerated concrete, concrete, screed, plaster or floor filling compounds, or natural organic substrates, such as wood, or to artificial substrates, such as polyvinyl chloride. The mineral expanding foam may also be applied to a wide variety of insulation materials, for example to fiberglass materials, polystyrene sheets, polyurethane sheets, mineral fiber sheets or mineral wool sheets.

The set mineral expanding foam has a dry bulk density after 28 days under standard climatic conditions (23° C., 50% relative humidity) of preferably 10 to 1000 kg/m³, particularly preferably 100 to 800 kg/m³ (determination method: based on EN 1015-6).

The mineral expanding foam (solid mortar) has a thermal conductivity after 28 days under standard climatic conditions (23° C., 50% relative humidity) of preferably 50 to 200 mW/mK, particularly preferably 30 to 100 mW/mK. The thermal conductivity is determined with the HFM 436 thermal conductivity measuring device from Netzsch in accordance with DIN EN 13163. The measurement is carried out with the “Lambda 10° C.” setting; the lower plate is set to 2.5° C. and the upper plate is set to 17.5° C. The test substrate is clamped in the middle and the measurement continues until the test substrate has reached a core temperature of 10° C.

Surprisingly, mineral expanding foam according to the invention can be used like polyurethane foam for filling cavities for example when installing windows or doors. In this case, the mineral expanding foam is very user-friendly. For example, protruding residues may be removed practically without leaving residues and without yellowing by simple scraping, for example using a spatula, or by washing, in contrast to polyurethane foams. Such residues of mineral expanding foam can be disposed of with household waste and are not hazardous waste in contrast to polyurethane foam. Cartridges filled with mineral expanding foam can be cleaned after their use and advantageously reused, which reduces the need for cartridges. Furthermore, the mineral expanding foam is UV-resistant, does not have a tendency toward yellowing and is in particular fire-resistant.

Furthermore, the set mineral expanding foam exhibits advantageous mechanical properties, in particular a high compressive strength or bending strength. The dry bulk density of the mineral expanding foam is also advantageously low.

It was particularly surprising here that the aqueous mineral expanding foam was also able to be applied as a one-component mixture (1K system) by means of cartridges and this application made it possible to obtain a foam with which conventional polyurethane foam can be substituted.

The examples which follow serve to elucidate the invention in more detail and should in no way be regarded as a restriction.

### Production of a Mineral Expanding Foam

### Example 1

The amount of water specified in Table 1 was added to a dry mixture of the components listed in Table 1 and after stirring for three minutes using a Toni mixer (level 2; 130 rpm) the ready-to-use aqueous mineral expanding foam was obtained having a cream-like consistency.

The thus obtained aqueous mineral expanding foam was placed in a cartridge and thus applied for filling a cavity.

The components of the mineral expanding foam:
Polymer powder: Polyvinyl alcohol-stabilized, water-redispersible polymer powder of a vinyl acetate-ethylene copolymer having a glass transition temperature of 16° C.;
Tylose MH 60010 P4 (trade name of Shin Etsu): etherified methyl hydroxyethyl cellulose (thickener);
Hostapur OSB (trade name of Shin Etsu): sodium salt of a C14/C16-α-olefinsulfonic acid;
Milke CEM I 52,5R: Portland cement;
Fondu Lafarge (trade name of Imerys): calcium aluminate cement (quick-setting cement);
Walhalla Edelhydrat: calcium hydroxide (Ca(OH)₂) (latently hydraulic binder);
Expandal 9-6355 (trade name of Benda-Lutz): metallic aluminum powder.

TABLE 1
Formulation of the mineral expanding foam from Example 1:

| | Example 1 [parts by weight] |
|---|---|
| Polymer powder | 100 |
| Tylose MH 60010 P4 | 12 |
| Hostapur OSB | 8 |
| Sodium hydrogencarbonate | 4 |
| Milke CEM I 52,5R | 694 |
| Fondu Lafarge | 60 |
| Walhalla refined hydrated lime | 50 |
| Gypsum (anhydrite) | 40 |
| Expandal 9-6355 | 20 |
| Sodium carbonate | 10 |
| PAC hm 6.7/4 fibers | 2 |
| Water | 95 |

### Testing of the Mineral Expanding Foam From Example 1

The determination of wet density and dry density of the expanding foam was effected by means of a density measuring cup.

The determination of the bending strength and compressive strength and the production of the test specimen were effected in accordance with DIN 18555-3 and according to the storage conditions specified in Table 2.

The thermal conductivity was determined as specified further above in the general description. The test results are summarized in Table 2.

TABLE 2
Test results with the mineral expanding foam of Example 1:

| | Example 1 |
|---|---|
| Wet density [kg/m³] | 350 |
| Dry density [kg/m³] | 200 |
| Thermal conductivity [mW/mK] | 47 |
| Compressive strength 28dSCC^{a)} [N/mm²] | 0.50 |
| Bending strength 28dSCC^{a)} [N/mm²] | 0.27 |

^{a)}28dSCC: testing after 28 days of storage under standard climatic conditions.

### Comparative Example 2

A dry mixture was produced and made up by mixing with water as described for Example 1, with the sole differences that use was made of 24 parts by weight of sodium hydrogencarbonate but no Expandal 9-6355.

The thus obtained product was not able to be applied using a cartridge on account of its consistency and was therefore not suitable for filling a cavity.

1-15. (canceled)

16. A mineral expanding foam based on
one or more foam stabilizers,
one or more air pore formers selected from the group comprising ammonium salts or alkali metal salts of the hydrogencarbonates or carbonates,
optionally one or more fillers and optionally one or more additives, characterized in that the mineral expanding foam is additionally based on
one or more protective colloid-stabilized polymers of ethylenically unsaturated monomers in the form of aqueous dispersions or water-redispersible powders,
one or more latent air pore formers selected from the group comprising aluminum and silicon and alloys thereof and calcium carbides and
30% to 95% by weight, based on the dry weight of the mineral expanding foam, of cement, with the proviso that the proportion of latent air pore formers is ≥10% by weight, based on the total weight of air pore formers and latent air pore formers.

17. The mineral expanding foam as claimed in claim 16, wherein the mineral expanding foam is based on latent air pore formers to an extent of 0.01% to 10% by weight, based on the dry weight of the mineral expanding foam.

18. The mineral expanding foam as claimed in claim 16, wherein the mineral expanding foam is based on latent air pore formers to an extent of 0.01% to 15% by weight, based on the dry weight of the cement present in the mineral expanding foam.

19. The mineral expanding foam as claimed in claim 16, wherein the mineral expanding foam is based on latent air pore formers to an extent of 10% to 95% by weight, based on the total weight of the latent air pore formers and the air pore formers.

20. The mineral expanding foam as claimed in claim 16, wherein the mineral expanding foam is based on the latent air pore formers and the air pore formers to an extent of 10% to 95% by weight, based on the dry weight of the cement present in the mineral expanding foam.

21. The mineral expanding foam as claimed in claim 16, wherein the mineral expanding foam is based on the latent air pore formers and the air pore formers to an extent of 0.02% to 15% by weight, based on the dry weight of the mineral expanding foam.

22. The mineral expanding foam as claimed in claim 16, wherein the mineral expanding foam is based on gypsum to an extent of 0.1% to 20% by weight, based on the dry weight of the mineral expanding foam.

23. The mineral expanding foam as claimed in claim 16, wherein the mineral expanding foam is based on quick-setting cement to an extent of 0.5% to 40% by weight, based on the dry weight of all the cement present,
with quick-setting cement being selected from the group comprising aluminate cement, calcium sulfoaluminate cements and high-alumina cement.

24. The mineral expanding foam as claimed in claim 16, wherein the foam stabilizers are one or more surfactants selected from the group comprising olefinsulfonic acids; fatty acids or salts thereof; fatty alcohols; alkylphenols or hydroxyalkylphenols; alkyl and alkylaryl ether sulfates; alkylsulfonates, alkylarylsulfonates; esters or monoesters of sulfosuccinic acid; partial phosphoric esters; alkyl polyglycol ethers; alkylaryl polyglycol ethers; ethylene oxide/propylene oxide (EO/PO) block copolymers; N-methyl taurides; fatty acid alkylolamides; amine oxides; or phosphine oxides; sodium cocoyl dimethylaminoacetate; sulfobetaine and phosphoric esters; or
one or more polymers selected from the group comprising polyvinyl alcohols; polyvinyl acetals; polyvinylpyrrolidones; polysaccharides in water-soluble form; lignosulfonates;
poly(meth)acrylic acid; copolymers of (meth)acrylates with carboxy-functional comonomer units; poly(meth)acrylamide; polyvinylsulfonic acids and water-soluble copolymers thereof; melamine-formaldehydesulfonates; naphthalene-formaldehydesulfonates; styrene-maleic acid copolymers; and vinyl ether-maleic acid copolymers; or
one or more proteins selected from the group comprising casein, caseinate, soy protein; gelatin; and other proteins obtainable by protein hydrolysis of animal proteins; or enzymes of biotechnological origin.

25. The mineral expanding foam as claimed in claim 16, wherein the mineral expanding foam is based on protective colloid-stabilized polymers of ethylenically unsaturated monomers to an extent of 0.5% to 40% by weight, based on the dry weight of the mineral expanding foam.

26. The mineral expanding foam as claimed in claim 16, wherein the polymers of ethylenically unsaturated monomers are based on one or more monomers selected from the group comprising vinyl esters, (meth)acrylic esters, vinylaromatics, olefins, 1,3-dienes and vinyl halides.

27. The mineral expanding foam as claimed in claim 16, wherein the mineral expanding foam does not contain any fillers.

28. The mineral expanding foam as claimed in claim 16, wherein the mineral expanding foam contains 0.01% to 5% by weight, based on the dry weight of the mineral expanding foam, of one or more hydrophobizing agents selected from the group comprising fatty acids and derivatives thereof, waxes and organosilicon compounds.

29. A process for producing mineral expanding foam, in that a dry mixture is produced
by mixing one or more foam stabilizers, one or more air pore formers selected from the group comprising ammonium salts or alkali metal salts of the hydrogencarbonates or carbonates, optionally one or more fillers and optionally one or more additives and the thus obtained dry mixture is made up with water, characterized in that one or more protective colloid-stabilized polymers of ethylenically unsaturated monomers in the form of water-redispersible powders,
one or more latent air pore formers selected from the group comprising aluminum and silicon and alloys thereof and calcium carbides and
30% to 95% by weight, based on the dry weight of the mineral expanding foam, of cement are additionally introduced into the dry mixture,
with the proviso that the dry mixture is based on latent air pore formers to an extent of ≥ 10% by weight, based on the total weight of air pore formers and latent air pore formers.

30. A process for filling cavities wherein the cavities are filled with the mineral expanding foam of claim 16.
